(19) United States
(12) Patent Application Publication
(10) Pub. No.: US 2009/0129592 A1
(43) Pub. Date: May 21, 2009

(54) METHOD OF FORMING A SECURITIZED IMAGE

(76) Inventors: Gerhard Frederick Swiegers, Wheelers Hill Victoria (AU); Lawrence David McCarthy, Noble Park North Victoria (AU); Mathew John Ballard, Glen Waverley Victoria (AU)

Correspondence Address: LADAS & PARRY, 5670 WILSHIRE BOULEVARD, SUITE 2100, LOS ANGELES, CA, 90036-5679, US

(21) Appl. No.: 12/096,007

(22) PCT Filed: Dec. 5, 2006
(86) PCT No.: PCT/AU2006/001867

§ 371 Date: Sep. 24, 2008

(30) Foreign Application Priority Data
Dec. 5, 2005 (AU) 2005906818

(51) Int. Cl. G09C 5/00; G09G 5/00

(52) U.S. Cl. 380/54; 345/629

(57) ABSTRACT

There is disclosed a method of forming a securitized image comprising: obtaining a host image which is to be visible to an observer, obtaining a latent image to be concealed within the host image, adjusting the saturation of regions of at least one of the host image and the latent image such that when the latent image and the host image as adjusted are subsequently combined, the saturation of the combined regions will more closely approximate the saturation of corresponding regions of the original host image; and combining the latent image, and host image as adjusted to form a securitized image.

### FIELD

The present invention relates to a method of forming a securitized image as well as to security devices incorporating securitized images. In one embodiment an encoded latent image is concealed within a visible host image. Embodiments of the invention have application in the provision of security devices which can be used to verify the legitimacy and presence of a document or instrument, for example a credit card. Other embodiments can be used to provide novelty items which are protected against counterfeiting.

### BACKGROUND TO THE INVENTION

In order to authenticate and verify the originality of, and to prevent unauthorised duplication or alteration of documents such as banknotes, credit cards and the like, security devices are often incorporated. The security devices are designed to provide some proof of authenticity and deter copying. Despite the wide variety of techniques that are available, there is always a need for further techniques which can be applied to provide a security device.

A variety of techniques have been developed to conceal latent images within security documents and instruments. Perhaps the earliest such technique is the Watermark. In this approach, a latent image is provided on a paper substrate such that the image is invisible when the paper is viewed in reflection, but visible when it is viewed in transmission.

More recent means of concealing images for security applications include the technique known as “Scrambled Indicia” and described in analogue form in U.S. Pat. No. 3,937,565 and in a computerized, digital version in Patent WO 97/20298. In the latter technique, the computer program effectively slices the image to be hidden into parallel slivers called “input slices”. These are then scrambled, generating a series of thinner “output slices” that are incorporated into an image in a form that is incoherent to the human eye. When viewed through a special device containing many microscopically small lenses, the original image is, however, reconstituted, thereby rendering the hidden image visible.

Scrambled images of this type may be incorporated into a visible background picture by adjusting the thickness of the features in the scrambled images.

Patent WO 97/20298 also describes how the scrambled images may be routinely incorporated into a visible picture by the computer algorithm. An original image is digitised and separated into its cyan, magenta, yellow, and black components. One or more scrambled images are then incorporated into the cyan and magenta separations. These are substituted for the originals and the job is printed as normal.

A variety of patents also describe the concealment of latent images by “modulation” of the line- or dot patterns used to print images. In order to print an image, professional printers use a variety of so-called “screening” techniques. Some of these include round-, stochastic-, line-, and elliptical-screens. Examples of these screens are shown in U.S. Pat. No. 6,104,812. Essentially, the picture is broken up into a series of image elements, which are typically dots or lines of various shapes and combinations. These dots and lines are usually extremely small, being much smaller than the human eye can perceive. Thus, images printed using such screens appear to the eye to have a continuous tone or density.

Hidden images can be created by juxtapositioning two apparently similar line or dot screens with one another. Processes in which an image is hidden by changing the position, shape, or orientation of the line elements used in printing screens are formally known as “line modulation”. Processes in which the dots in a printer's screens are deformed or moved to conceal an image are known as “dot modulation”.

The theory of line and dot modulation is described by Amidror (Issac Amidror, “The Theory of the Moiré Phenomenon”, Kluwer Academic Publishers, Dordrecht, 2000, pages 185-187). When two locally periodic structures of identical periodicity are superimposed upon each other, the microstructure of the resulting image may be altered (without generation of a formal Moiré pattern) in areas where the two periodic structures display an angle difference of α=0°. The extent of the alteration in the microstructure can be used to generate latent images which are clearly visible to an observer only when the locally periodic structures are cooperatively superimposed. Thus, the latent images can only be observed when they are superimposed upon a corresponding, non-modulated structure. Accordingly, a modulated image can be incorporated in an original document and a decoding screen corresponding to the non-modulated structure used to check that the document is an original—e.g. by overlaying a modulated image with a non-modulated decoding screen to reveal the latent image.

Examples of concealing latent images using line modulations are described in various patents, including the following: U.S. Pat. No. 6,104,812, U.S. Pat. No. 5,374,976, CA 1,066,109, CA 1,172,282, WO03/013870-A2, U.S. Pat. No. 4,143,967, WO91/11331, and WO2004/110773 A1. One such technique, known as Screen Angle Modulation, “SAM”, or its micro-equivalent, “μ-SAM”, is described in detail in U.S. Pat. No. 5,374,976 and by Sybrand Spannenberg in Chapter 8 of the book “Optical Document Security, Second Edition” (Editor: Rudolph L. van Renesse, Artech House, London, 1998, pages 169-199), both incorporated herein by reference. In this technique, latent images are created within a pattern of periodically arranged, miniature short-line segments by modulating their angles relative to each other, either continuously or in a clipped fashion. While the pattern appears as a uniformly intermediate colour or grey-scale when viewed macroscopically, a latent image is observed when it is overlaid with an identical, non-modulated pattern on a transparent substrate.

Examples of concealing latent images using dot modulations are described in various patents, including WO02/23481-A1.

In order to overcome the limitation that latent images that are hidden using scrambling-, line- or dot-modulation are often clearly visible under optical magnification, we have recently developed techniques in which the tiniest possible image elements available to the printer (the “pixels”) are manipulated to create an entirely new type of printing screen. Such techniques can be described as “half-toning” hidden images. At least two techniques that manipulate printer's pixels to create half-toned hidden images are known. These approaches are known broadly as “Modulated Digital Images” (MDI). They are exemplified in the processes described in WO2005002880-A1 and WO2004109599-A1, which describe the devices known as PhaseGram and BinaGram.

In PhaseGram, multiple images, such as photographic portraits, are digitized and then separated into their various grey-scales or colour hue saturations. Line screens with various displacements are then overlaid in the black areas of each of these separations, with the line screens displaced according to the grey scale or hue saturation of the separation. The adjusted images are then combined to create a new printing screen. All of this is done in a digital process by a computer algorithm. The use of a digital computer method allows for variations in the construction and final presentation of the hidden image that are not possible using a comparable analogue (photographic) process. The new printing screens are extremely complex, defying human observation of the hidden image(s) even at full magnification.

BinaGram is similar in concept to PhaseGram, involving as it does a computer algorithm to generate a new printing screen. In this case however, the fundamental principle used is not that of displaced line screens, but rather the principle of compensation in which each element of the hidden image is paired with a new element of complementary density.

Such devices may be incorporated into a visible image using the technique known as TonaGram and described in WO2005/069198-A1. TonaGram involves a technique for manipulating the tonal values of one or more latent images and a host image such that the latent images are hidden by assigning a tonal range to the latent image. In this way, latent images, such as BinaGram, PhaseGram, or other hidden images, may be concealed within visible, host images.

It would be desirable to provide another technique concealing one or more images within a visible image.

### SUMMARY OF THE INVENTION

In an embodiment, the invention provides a method of forming a securitized image comprising:
a) obtaining a host image which is to be visible to an observer;
b) obtaining a latent image to be concealed within the host image;
c) adjusting the saturation of regions of at least one of the host image and the latent image such that when the latent image and the host image as adjusted are subsequently combined, the saturation of the combined regions will more closely approximate the saturation of corresponding regions of the original host image; and
d) combining the latent image and host image as adjusted to form a securitized image.

In an embodiment, the invention comprises adjusting the saturation to seek to minimise the difference between the saturation of the combined, latent image and host image as adjusted and the original host image.

In an embodiment, the invention comprises adjusting the saturation of regions of at least one of the host image and the latent image comprises:
separating each of the host image and the latent image into a set of digitized greyscale or colour saturations which fully define each image when combined,
applying within each greyscale or colour saturation, a matching algorithm to match the grey-scale or colour characteristics of image elements in the latent image with corresponding image elements in the same greyscale or colour saturations of the host image.

In an embodiment, the invention comprises combining the latent image and host image as adjusted comprises:
transforming selected image elements within each greyscale or colour saturation in the host image according to the visual characteristics of the selected, corresponding image elements of the latent image to form revised separations; and
combining the revised separations to thereby create the securitized image.

In an embodiment, the invention comprises obtaining a latent image comprises selecting one or more images that are to be hidden within the host image and forming a latent image containing the one or more images.

In an embodiment, the invention comprises:
a) obtaining at least a further latent image to be concealed;
b) adjusting the saturation of regions of at least one of the securitized image and the further latent image such that when the further latent image and the securitized image as adjusted are subsequently combined, the saturation of the combined regions will more closely approximate the saturation of corresponding regions of the original securitized image; and
c) combining the further latent image and securitized image as adjusted to form a further securitized image.

In an embodiment, the invention comprises the latent image is an encoded hidden image which can be decoded using a decoding screen.

In an embodiment, the invention comprises forming a latent image by a technique selected from the group of Scrambled Indicia, Line- or Dot-Modulation, PhaseGram; and BinaGram.

In an embodiment, the latent image is a digitally modulated image.

In an embodiment, the invention comprises a plurality of latent images are concealed within a visible, securitized image in such a manner that they can each be decoded by a different decoder.

The invention also extends to security devices incorporating securitized images made in accordance with the above methods.

Such security devices may be stand alone devices (e.g. printed on a substrate) or may be incorporated as parts of documents, instruments etc.—for example, they may be used in passports, security cards, credit cards and bank notes.

Thus, the invention provides a security device comprises a securitized image in which a latent image is concealed within a host image by adjusting the saturation of regions of at least one of the host image and the latent image such that when the latent image and the host image as adjusted are subsequently combined, the saturation of the combined regions will more closely approximate the saturation of corresponding regions of the original host image and combining the latent image and host image as adjusted to form a securitized image.

In an embodiment, the latent image is an encoded hidden image which can be decoded using a decoding screen.

In an embodiment, the latent image is a digitally modulated image.

In an embodiment, a plurality of latent images are concealed within a visible, securitized image in such a manner that they can each be decoded by a different decoder.

Persons skilled in the art will appreciate that the method of the invention will typically be embodied in program code that carries out the above method (or enables steps such as selecting to be performed by a user) and that the invention extends to such program code. Such program code will typically be embodied on a storage medium.

Accordingly, the invention provides computer program code which when executed by a computer causes the computer to carry out a method of forming a securitized image comprising:
a) obtaining a host image which is to be visible to an observer;
b) obtaining a latent image to be concealed within the host image;
c) adjusting the saturation of regions of at least one of the host image and the latent image such that when the latent image and the host image as adjusted are subsequently combined, the saturation of the combined regions will more closely approximate the saturation of corresponding regions of the original host image; and
d) combining the latent image and host image as adjusted to form a securitized image.

The term “securitized image” is used to refer to an image which contains one or more hidden images. It will be appreciated that the hidden image need only be in a portion of the area of the security image. As colour- or greyscale tones are manipulated to conceal the images, such securitized images are referred to herein as “Total Colour Management”- or “TCM”-Devices.

In this specification, “image elements” refer to image portions which are manipulated collectively. Typically, these will be the smallest image elements available for the display or reproduction technique selected (e.g. the pixels of printers or display-devices), however, they may be groups of the smallest available image elements (e.g. a 2×2 matrix of pixels), depending on the desired resolution and reproduction technique.

Herein, the term “primary visual characteristic” is used to refer to the set of possible visual characteristics which an image element can take after digitization. The primary visual characteristics will depend on the nature of the original image, and in the case of colour images, on the colour separation technique which is used.

In the case of grey-scale images, the primary visual characteristics are typically black and white.

In the case of colour images, colour separation techniques such as RGB or CYMK may typically be used. For RGB the primary visual characteristics are red, green and blue, each in maximum saturation. For CYMK, the primary visual characteristics are cyan, yellow, magenta and black, each in maximum saturation.

The value the visual characteristic takes after transformation will typically relate to the density of the image elements. That is, where the original image is a grey-scale image, the visual characteristic may be a grey-scale value and where the original image is a colour image, the visual characteristic may be a saturation value of the hue of the image element.

A complementary visual characteristic is that density of grey or hue which, which combined with the original visual characteristic, delivers an intermediate tone. In the case of grey-scale elements, the intermediate tone is grey. For colour image elements, the complementary hues are as follows:

| Hue | Complementary hue |
|---|---|
| cyan | red |
| magenta | green |
| yellow | blue |
| black | white |
| red | cyan |
| green | magenta |
| blue | yellow |

Typically, the image elements in a host or hidden image will be rectangularly arrayed. However, the image elements may be arranged in other shapes.

Further features of the invention will become apparent from the following description of preferred embodiments of the invention.

### BRIEF DESCRIPTION OF THE DRAWINGS

Preferred embodiments of the invention will be described with reference to the accompanying drawings:

FIG. 1 is a flow chart illustrating an example of how a monochrome latent image may be concealed within a colour host image according to the first preferred embodiment;

FIG. 2 is a flow chart illustrating an example of an algorithm for modifying a host image to contain a concealed latent image according to the first preferred embodiment;

FIG. 3 is a diagrammatic explanation of the algorithm used in the first preferred embodiment;

FIGS. 4A and 4B are flow-charts showing how a latent and a host colour image may be separated into constituent colour separations;

FIG. 5 is a flow chart showing how a colour hidden image would typically be converted into the constituent CYMK separations of a colour PhaseGram;

FIGS. 6A to 6D are flow charts showing how the “original” Cyan, Magenta, Yellow and Black separations of a CYMK latent image are typically converted into “revised” Cyan, Magenta, Yellow and Black separations, by taking into account the complementary colours in the negatives of the other separations;

FIGS. 7A to 7D are flow charts showing how the separations of the host image are transformed according to the corresponding “revised” separations of the latent image, to thereby create the separations of the final, securitized image; and

FIG. 8 is a block diagram of a computing system of the preferred embodiment.

### DESCRIPTION OF THE PREFERRED EMBODIMENTS

The preferred embodiments provide techniques for forming a securitized image. A latent image is concealed within a host image which is to be visible to a human observer. The securitized image is formed by adjusting the saturation of regions of at least one of the host image in the latent image such that when the latent image and the host image are subsequently combined, the saturation of those regions will more closely approximate the saturation of the corresponding regions of the original host image.

Persons skilled in the art will appreciate that computer program code may be used to carry out the technique described below, either by carrying out the steps or requiring a user to input information, such as a selection of a host or latent image into the system. Such program code can be provided on a disc or supplied to users in other ways such as by download over the Internet.

### Preferred Embodiment 1

This embodiment is most suitable, but is not limited to cases where the host image may be either black-and-white (greyscale) or colour, but where the latent image is only black-and-white.

In greyscale images, the original image is typically a picture consisting of an array of pixels of differing shades of grey. Each shade of grey corresponds to a different intensity of black (or of its complementary colour, white). However, the image may be a colour image which is subjected to an additional image processing step to form a grey-scale image so as to create a grey-scale effect in the final, securitized image.

In colour images, the original image is typically a picture consisting of an array of pixels of differing colour hues, each with an associated saturation that corresponds to the intensity of the hue (or of its complementary hue).

Primary hues are colours that can be separated from an original image by various means known to those familiar with the art. A primary hue in combination with other primary hues at particular saturations (intensities) provides the perception of a greater range of colours as may be required for the depiction of the subject image. Examples of schemes which may be used to provide the primary hues are red, green and blue in the RGB colour scheme and cyan, yellow, magenta, and black in the CYMK colour scheme. Both colour schemes may also be used simultaneously. Other colour spaces or separations of image hue into any number of primaries with corresponding complementary hues may be used.

In black-and-white image, only one hue is present: black (with its corresponding complementary hue, white). As such, black-and-white images can be considered a special case of colour images.

Saturation is the level of intensity of a particular primary hue within individual pixels of the original image. Colourless is the lowest saturation available; the highest corresponds to the maximum intensity at which the primary hue can be reproduced.

Any digital system employed to depict continuous tone images has to reduce the number of shade levels to a discrete number. This applies to both grey scale and colour images. According to one standard (8 bit), the range of shades employed is 256, numbered from 0 to 255 and defined as levels of light output from a computer monitor. Hence in a grey scale depiction, 255 is white and 0 is black (i.e. there are 8 bits for each of red, green, and blue). Using the red-green-blue (RGB) colour system, (255R, 255G, 255B) is white and (0R, 0G, 0B) is black. Other standards incorporate 65,536 tones (at least for grey; 16 bit standards) and 4096 tones (12 bit standard). Similar standards are used for other colour separation techniques such as CYMK.

Saturation can therefore be expressed as a fraction (i.e. colourless=0 and maximum hue=1) or a percentage (i.e. colourless=0% and maximum hue=100%) or by any other standard values used by practitioners of the art (e.g. as a value between 0 (maximum saturation) and 255 (colourless) in the 256-colour scheme).

The number of primary hues (N_{H}) and their complementary and mixed hues in an image typically depends upon the media to be used to produce the image. In the case of the RGB and CYMK primary colour schemes, the complementary hues are as follows;

| | | Hue | Complementary hue |
|---|---|---|---|
| A. | CYMK | cyan | red (made up of magenta and yellow) |
| | | magenta | green (made up of cyan and yellow) |
| | | yellow | blue (made up of cyan and magenta) |
| | | black | white |
| | | white | black (made up of cyan, magenta, and |
| | | | yellow, in printing at least) |
| B. | RGB | red | cyan (made up of green and blue) |
| | | green | magenta (made up of red and blue) |
| | | blue | yellow (made up of red and green) |

As is convention, white refers to colourless pixels.

The mixed hues are as follows:

| | | Hues | Mixed hue |
|---|---|---|---|
| A. | CYMK | cyan + magenta | blue |
| | | magenta + yellow | red |
| | | cyan + yellow | green |
| | | any colour + black | black |
| | | any colour + white | that colour |
| | | any colour + itself | that colour |
| B. | RGB | red + blue | magenta |
| | | blue + green | cyan |
| | | red + green | yellow |
| | | any colour + itself | that colour |

Other colour spaces or separations of hue with corresponding complementary hues, known to the art, may be used.

In the preferred embodiment, after selecting a host image the following steps are then followed:

1. An area within which the latent image is to be concealed within the host image is identified. This area may be the whole of the host image or only a part of the host image. The image or images to be hidden within this area are then adjusted (using methods known to the art) to be identical in size to this area and where there is more than one combined into a single “latent” image using digital or analogue techniques previously described. It is preferred that a Modulated Digital Image technique, such as greyscale BinaGram, PhaseGram is employed.

The processes for producing a PhaseGram or a BinaGram are described in WO2005002880-A1 and WO2004109599-A1.

In PhaseGram, multiple images, such as photographic portraits, are digitized and then separated into their various grey-scales or colour hue saturations. Line screens with various displacements are then overlaid in the black areas of each of these separations, with the line screens displaced according to the grey scale or hue saturation of the separation. The adjusted images are then combined to create a new printing screen. All of this is done in a digital process by a computer algorithm. The use of a digital computer method allows for variations in the construction and final presentation of the hidden image that are not possible using a comparable analogue (photographic) process. The new printing screens are extremely complex, defying human observation of the hidden image(s) even at full magnification.

BinaGram is similar in concept to PhaseGram, involving as it does a computer algorithm to generate a new printing screen. In this case however, the fundamental principle used is not that of displaced line screens, but rather the principle of compensation in which each element of the hidden image is paired with a new element of complementary density.

2. If the images are not already digitized, each of the host and latent image is now digitized into an equivalent regular array (or matrix) of pixels using methods known to the art. That is, the host and latent image are converted into sets of pixels. In the case of the host image, these pixels may contain one or more hues and saturations. In the case of the latent image, this embodiment demands that they consist of pixels which are either black (i.e. maximum greyscale saturation, e.g. 0) or colourless (i.e. minimum greyscale saturation, e.g. 255). Persons skilled in the art will appreciate that for some digital techniques employed, such as greyscale PhaseGram or BinaGram, the latent image should already be a greyscale digitized latent image. In that case, this step is not necessary. However, other concealment methods may not generate such digitizations. In such cases, dithering techniques, like an ordered dither or an error-diffusion dither (like a Floyd-Steinberg, Burkes, or Stucki procedure, etc.), may be used to ensure that all pixels in the latent image are in either maximum (black) or minimum (colourless) greyscale saturation.

3. The host image is then separated into its constituent colour separations. These colour separations will typically match those capable of being rendered by the printer or device to be used to display the final, securitized image. As such, this step may be limited to a single separation (for black-and-white rendering) or to multiple separations (e.g. to four separations for the CYMK colour scheme). Non-conventional separations are also possible, provided that their combination generates the original image roughly accurately. These separations are known as the “original separations”.

4. Within the latent image and each separation of the host image, each pixel is now assigned a unique address (i,j) or (p,q) according to its position in the [i×j] matrix of pixels in the host image or its position in the [p×q] matrix of pixels in the latent image. (If the image is not a rectangular array, then the position of pixels can be defined relative to an arbitrary origin, preferably one which gives positive values for both co-ordinates i and j or p and q). The area in the host image within which the latent image is to be concealed must necessarily contain a matrix of p×q pixels. That is, it must be of identical size and contain an identical arrangement of pixels as exists in the latent image.

5. Within the latent image and each separation of the host image, each pixel is further designated as belonging to the host image (Hᵢⱼ) or to the latent image (L_{pq}).

6. Within the latent image and each separation of the host image, each pixel is assigned a descriptor, h, which indicates whether it is black (or white) or one of the selected primary hues, where h=1 (hue 1) or 2 (hue 2) . . . NH (hue NH, where NH=an integral number). Each pixel is now assigned as being H^{h}ᵢⱼ or L^{h}_{pq}.

7. Within the latent image and each separation of the host image, the saturation, s, of the hue of each pixel is now defined and the pixel is designated H^{h}ᵢⱼ(s) or L^{h}_{pq}(S), where the number of saturation levels available is w, and s is an integral number between, or incorporating 0 (maximum saturation level) and w (minimum saturation level).

8. Within each separation of the host image, a matching algorithm is now applied in which the p×q matrix of pixels in the host image is transformed according to the comparable visual characteristics of the p×q matrix in the latent image, for each value of h. Several matching algorithms may be employed, depending on specific conditions and the latent image employed. In general a matching algorithm aims to:
move intensity (hue saturation) within the host image from regions that are colourless (saturation=w) in the corresponding latent image to regions that are black (saturation=0) in the corresponding latent image, subject to the constraint that the overall saturation of the host image within the smallest possible regions of the image remains as close as possible to constant.

Thus, a preferred embodiment of the matching algorithm when using a latent image consisting entirely of pixels having either no saturation (colourless; saturation w) or maximum saturation (saturation=0) will be as follows:

For each value of h, the average saturation, M, of the latent image is calculated by averaging all of the values of s in L^{h}_{pq}(s). M must then lie between w (minimum saturation level) and 0 (maximum saturation level).

Every pixel H^{h}_{pq}(s) is now transformed as follows:
When L^{h}_{pq}(s) has saturation s=w, and the saturation of H^{h}_{pq}(s) is s<M:
   then H^{h}_{pq}(s) is transformed into H^{h}_{pq}(s′) where s′=(w*s)/M, in which s=the original saturation of H^{h}_{pq}(s). This equation reflects the need to reduce the intensity of the pixel in the host image in order to incorporate the hidden image. The derivation of this equation is described in example 1.
When L^{h}_{pq}(s) has saturation s=w, and the saturation of H^{h}_{pq}(s) is s≧M:
   then H^{h}_{pq}(s) is transformed into H^{h}_{pq}(s′) where s′=w. This equation reflects the need to increase the intensity of the pixel in the host image in order to incorporate the hidden image. The derivation of this equation is described in example 1.
When L^{h}_{pq}(s) has saturation s=0, and the saturation of H^{h}_{pq}(s) is s<M:
   then H^{h}_{pq}(s) is transformed into H^{h}_{pq}(s′) where s′=0. This equation reflects the need to decrease the intensity of the pixel in the host image in order to incorporate the hidden image. The derivation of this equation is described in example 1.
When L^{h}_{pq}(s) has saturation=0, and the saturation of H^{h}_{pq}(s) is s≧M:
   then H^{h}_{pq}(s) is transformed into H^{h}_{pq}(s′) where s′={(w*(s−M)/(w−M)}, in which s=the original saturation of H^{h}_{pq}(s). This equation reflects the need to increase the intensity of the pixel in the host image in order to incorporate the hidden image. The derivation of this equation is described in example 1.

The resulting separations of the host image now contains pixels within the p×q matrix which have been transformed. The separations are therefore termed “revised separations”.

It is to be understood that a variety of different algorithms may be used to achieve a concealment of the latent image within the host image. For example, the above algorithm may be adjusted to take into account dot gain during printing of the securitized image. Other variables like ink transparency, stock (paper) colour, stock texture, dot overlap, etc., may all influence the algorithm employed. Alternatively, the above equations may be empirically modified or altered to achieve suitable concealment. Persons skilled in the art will appreciate that sub-optimum techniques may provide adequate concealment wherein the saturation of portions of the host and/or latent image is adjusted to more closely approximate the saturation of the original host image. To obtain the best results, the intention should be to best match pixels of the latent image to the corresponding pixels of the host image, thereby allowing imperceptible concealment of the latent image within the host image.

9. The revised separations are now combined into a single image, using methods known to the art. For example, each of the separations may reduced to monochrome and then constituted as a separate printing plate; in printing each plate in its corresponding colour, in overlay with each other, the final single image is generated. Alternatively, the revised separations may be directly combined with each other without further manipulation, as in, for example, a computer monitor or other similar display device.

The new single image is known as the “securitized” image and it contains the latent image and its constituent hidden images imperceptibly concealed within it. The hidden images are revealed by applying the appropriate decoding process to the securitized image.

### Preferred Embodiment 2

This preferred embodiment differs from the foregoing one in taking into account the complementary colours of the primary hues within the latent image, thereby allowing accurate rendering of colour hidden images within colour host images. However, while suitable for this application, its use is not limited to this application.

Embodiment 2 involves the following steps:

1. An area within which the latent image is to be concealed within the host image is identified. This area may be the whole of the host image or only a part of the host image. The image or images to be hidden within this area are then adjusted (using methods known to the art) to be identical in size to this area. The images to be hidden within this area are then also combined into a single “latent” image using digital or analogue techniques previously described, such as BinaGram, PhaseGram, and the like. This preferred embodiment includes, but is not limited to, the use of latent images which are coloured; that is, which contain image elements having different primary hues.

2. The host and latent image is now separated into its constituent colour separations. These colour separations will typically match those capable of being rendered by the printer or device to be used to display the final securitized image. As such, this step may be limited to a single separation (for black-and-white rendering) or to multiple separations (e.g. to four separations for the CYMK colour scheme). Non-conventional separations are also possible, provided that their combination generates the original image reasonably accurately. In all cases, these separations are known as the “original separations”.

3. If the images are not already digitized, each of the host and latent image colour separations is now digitized into an equivalent regular array (or matrix) of pixels using methods known to the art. That is, the host and latent image are converted into sets of pixels. These pixels may contain one or more hues and saturations. Persons skilled in the art will appreciate that for some digital techniques such as colour PhaseGram or BinaGram, a colour digitized latent image will already exist. In that case, this step will not be necessary. However, other concealment methods may not generate such digitizations. In such cases, dithering techniques, like an ordered dither or an error-diffusion dither (like a Floyd-Steinberg, Burkes, or Stucki procedure, etc.), may be used to ensure that all pixels in the latent image contain suitable hues and their relevant saturations.

It should be noted that certain methods of creating latent images must be digitized and encoded before being colour separated, whilst others must be colour separated before being digitized. Thus, step 2 and 3 may be carried out simultaneously or in a different order to that described above.

Using techniques such as PhaseGram or BinaGram, the preferred method of concealing a hidden image and separating it into its constituent colour separations involves the following procedure:
(a) The hidden images, which may be analogue or digital, are separated into their constituent colours,
(b) Each colour separation is digitized into a grey-scale image containing a pre-selected number of shades.
(c) Each colour separation is converted into its respective PhaseGram or BinaGram using methods described previously.
(d) The intensity range of the resulting colour separated PhaseGrams from (c) above are adjusted to match the intensity range of the digitized images described in (b) above.
(e) The resulting images are converted back to their original primary hues, giving digitized, colour separations containing the hidden images.
(f) When multiple images have been hidden, all separations of the same hue are combined into a single colour separation using means known to the art. If the resulting colour separations are combined into a single image, then the latent image is generated. The images within the latent image are revealed in colour when decoded using suitable means.

4. Within each separation of the host and latent images, each pixel is now assigned a unique address (i,j) or (p,q) according to its position in the [i×j] matrix of pixels in the host image or its position in the [p×q] matrix of pixels in the latent image. (If the image is not a rectangular array, then the position of pixels can be defined relative to an arbitrary origin, preferably one which gives positive values for both co-ordinates i and j or p and q). The area in the host image within which the latent image is to be concealed must necessarily contain a matrix of p×q pixels. That is, it must be of identical size and contain an identical arrangement of pixels as exists in the latent image.

5. Within each separation of the host and latent images, each pixel is further designated as belonging to the host image (Hᵢⱼ) or to the latent image (L_{pq}).

6. Within each separation of the host and latent images, each pixel is assigned a descriptor, h, which indicates whether it is black (or white) or one of the selected primary hues, where h=1 (hue 1) or 2 (hue 2) . . . NH (hue NH, where NH=an integral number). Each pixel is now assigned as being H^{h}ᵢⱼ or L^{h}_{pq}.

7. Within each separation of the host and latent images, the saturation, s, of the hue of each pixel is now defined and the pixel is designated H^{h}ᵢⱼ(s) or L^{h}_{pq}(s), where the number of saturation levels available is w, and s is an integral number between, or incorporating 0 (maximum saturation level) and w (minimum saturation level).

8. Each separation of the latent image is now converted into its negative using means known to the art. In this process the primary hues for each pixels will be converted into their complementary hues. The complementary colours are designated h=−1 (hue complementary to hue 1), −2 (hue complementary to hue 2), . . . −NH (hue complementary to hue NH). Thus, the process of converting the separated latent images into their complementary hues will result in the pixel L^{h}_{pq}(s) generally becoming L^{h}_{pq}(s). Moreover, because each complementary hue consists of a mixture of the original primary hues, L^{-h}_{pq}(s) can be expressed as L^{h′+h″}_{pq}(s) where hues h′+h″ give hue −h. The pixels L^{h′+h″}_{pq}(s) are further expressed as L^{h′}_{pq}(s)+L^{h″}_{pq}(s).

For example, a cyan pixel (where, say, h=1) will, when converted to its negative, become a red pixel (h=−1). However, red is made up of magenta (say, h=2) and yellow (say, h=3). Thus, the process of making a pixel (L¹_{pq}(s)) negative makes it a combination of two of the other primary hues (L²⁺³_{pq}(s)), This is now expressed as L²_{pq}(s)+L³_{pq}(s).

9. Pixels containing the same primary hue in each of the original separations of the latent image and their negatives are now combined into a single separation. Thus, each original separation of the latent image, L^{h}_{pq}(s), now has correspondingly coloured pixels in the negatives of the other separations (L^{h′+h″}_{pq}(s)) of the latent image added to it. That is, for the original separation corresponding to hue h in the latent image, every pixel L^{h}_{pq}(s) has added to it L^{h′}_{pq}(s) if h′=h, or L^{h″}_{pq}(s) if h″=h. The resulting separations are designated L^{h}_{pq}(s) and are termed the “revised latent image separations”.

10. Each of the revised latent image separations is now dithered so that the saturation of pixels becomes either no saturation (colourless; saturation=w) or maximum saturation (saturation=0). That is, L^{h}_{pq}(s) is converted to L^{h}_{pq}(s=0) or L^{h}_{pq}(s=w). This may be achieved using any dithering technique, such as an ordered dither or an error-diffusion dither (like a Floyd-Steinberg, Burkes, or Stucki procedure, etc).

11. Within each separation of the host and latent images, a matching algorithm is now applied in which the p×q matrix of pixels in the host image is transformed according to the comparable visual characteristics of the p×q matrix in the latent image, for each value of h. Several matching algorithms may be employed, depending on specific conditions and the latent image employed. In general, a matching algorithm acts to:
move intensity (hue saturation) within the host image from regions that are colourless (saturation=0) in the corresponding latent image to regions that are black (saturation=maximum) in the corresponding latent image, subject to the constraint that the overall saturation of the host image within incrementally smaller regions of the image remains as close as possible to constant.

Thus, a preferred embodiment of the matching algorithm will be as follows:
for each value of h, the average saturation, M, of the latent image is calculated by averaging all of the values of s in L^{h}_{pq}(s) where s may be the original s (as found in step 8) or where s is constrained to be either 0 or w (as is done in step 9). M must then lie between 0 (minimum saturation level) and w (maximum saturation level).

Every pixel H^{h}_{pq}(s) is now transformed as follows:
When L^{h}_{pq}(s=0 or w) has saturation s=w, and the saturation of H^{h}_{pq}(s) is s<M:
   then H^{h}_{pq}(s) is transformed into H^{h}_{pq}(s′) where s′=(w*s)/M, in which s=the original saturation of H^{h}_{pq}(s). This equation reflects the need to reduce the intensity of the pixel in the host image in order to incorporate the hidden image. The derivation of this equation is described in example 1.
When L^{h}_{pq}(s=0 or w) has saturation s=w, and the saturation of H^{h}_{pq}(s) is s s≧M:
   then H^{h}_{pq}(s) is transformed into H^{h}_{pq}(s′) where s′=w. This equation reflects the need to increase the intensity of the pixel in the host image in order to incorporate the hidden image. The derivation of this equation is described in example 1.
When L^{h}_{pq}(s=0 or w) has saturation s=0, and the saturation of H^{h}_{pq}(s) is s<M:
   then H^{h}_{pq}(s) is transformed into H^{h}_{pq}(s′) where s′=0. This equation reflects the need to decrease the intensity of the pixel in the host image in order to incorporate the hidden image. The derivation of this equation is described in example 1.
When L^{h}_{pq}(s=0 or w) has saturation s=0, and the saturation of H^{h}_{pq}(s) is M:
   then H^{h}_{pq}(s) is transformed into H^{h}_{pq}(s′) where s′={(w*(s−M)/(w−M)}, in which s=the original saturation of H^{h}_{pq}(s). This equation reflects the need to increase the intensity of the pixel in the host image in order to incorporate the hidden image. The derivation of this equation is described in example 1.

The resulting separations of the host image now contains pixels within the p×q matrix which have been transformed. The separations are therefore termed “revised separations”.

It is to be understood that a variety of different algorithms may be used to achieve a concealment of the latent image within the host image. For example, the above algorithm may be adjusted to take into account dot gain during printing of the securitized image. Other variables like ink transparency, stock (paper) colour, stock texture, dot overlap, etc., may all influence the algorithm employed. Alternatively, the above equations may be empirically modified or altered to achieve suitable concealment. Persons skilled in the art will appreciate that sub-optimum techniques may provide adequate concealment in that the saturation of portions of the host and/or latent image is adjusted to more closely approximate the saturation of the original host image. To obtain the best results, the intention should be to best match pixels of the latent image to the corresponding pixels of the host image, thereby allowing imperceptible concealment of the latent image within the host image.

12. The revised separations are now combined into a single image, using methods known to the art. For example, each of the separations may reduced to monochrome and then constituted as a separate printing plate; in printing each plate in its corresponding colour, in overlay with each other, the final single image is generated. Alternatively, the revised separations may be directly combined with each other without further manipulation, as in, for example, a computer monitor or other similar display device.

The new single image is known as the “securitized” image and it contains the latent image and its constituent hidden images imperceptibly concealed within it. The hidden images are revealed by applying the appropriate decoding process to the securitized image.

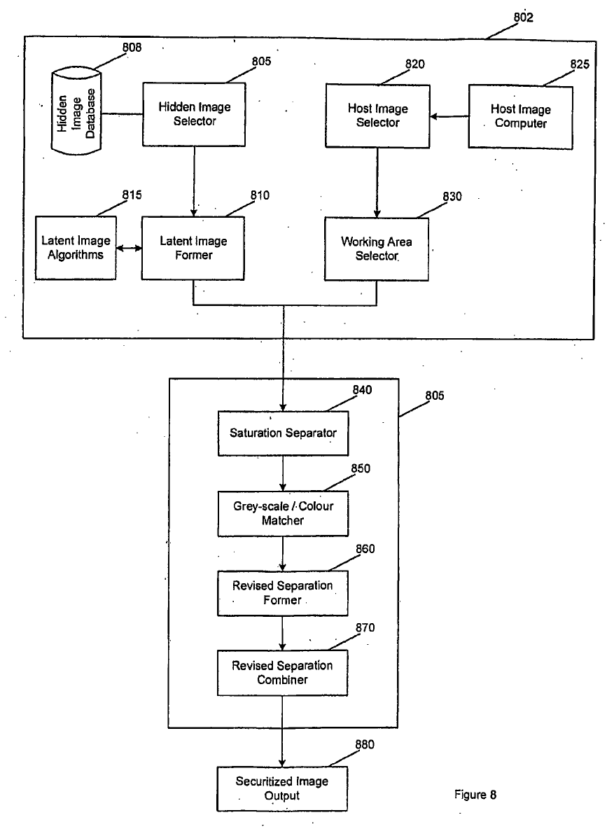

FIG. 8 shows a computing system of the preferred embodiment. The computing system comprises an input section 802, an image processing, section 835 and an output section 880. The input section 802 is arranged to allow a user to input a hidden image and a host image that will subsequently be processed. The hidden image selector 805 allows the user to navigate the file system of a computer to access an image that is to be hidden. Typically the hidden image (or more than one hidden image) would be retrieved from hidden image database 808. Once the user has selected the hidden image using the hidden image selector 805, the hidden-image is provided to the latent image former 810. The latent image former may automatically form a latent image by applying a latent image algorithm or the algorithm may be selected by the user from a database of latent image algorithms 815.

The host image that is obtained may be, for example a picture of a person in relation to whom an identity card is to produced. Accordingly, the system includes a host image capturer 825 which may be a digital camera or the like connected to the system and a host image selector 820 used to select a captured host image for further processing. Persons skilled in the art will also appreciate that host images could be retrieved using the file system.

The system also incorporates a working area selector 830 that allows a user to select where in the host image the latent image is to be incorporated. For example, in a sub-region of the image. It will also be appreciated by persons skilled in the art that rules for automatically locating the latent image may be implemented by a working area selector 830.

After the working area has been selected, the host image, together with data defining the working area and the latent image are supplied to an image processing section 835. The image processing section includes a saturation separator 840, a grey-scale/colour matcher 850, a revised separation former 860 and a revised separation combiner 870. Once the revised separations have been combined by the revised separation combiner 870, the securitized image has been formed and is provided to the securitized image output 880. Typically the securitized image output will be a form of printer for printing the securitized image.

### Example 1

### Monochrome Latent Image in Full-Colour Host Image

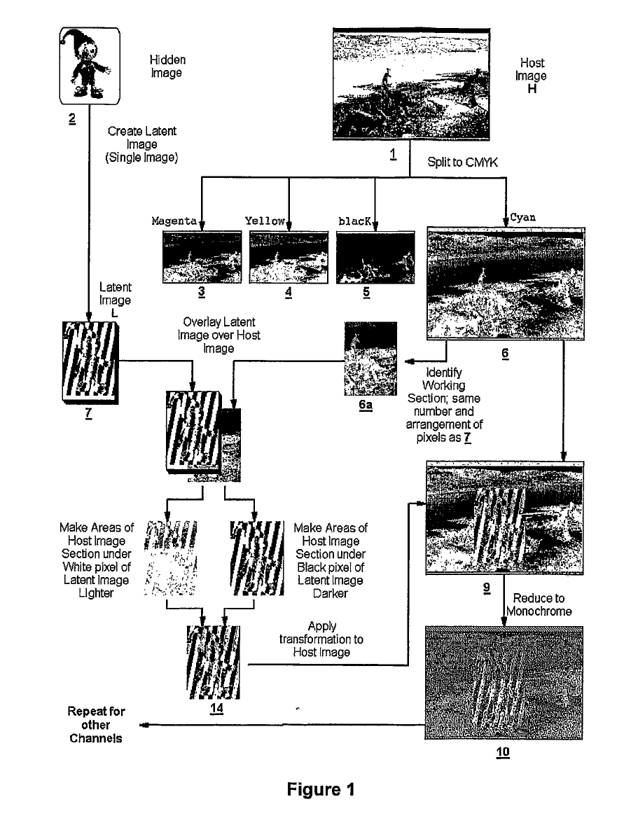

Referring to FIG. 1: A host image consists of a full colour picture indicated as 1. Host image 1 will typically be input by a user of a computer that executes program code putting the technique to effect. For example, by selecting a host image stored on the computer. An image 2 that is to be hidden within the host image is, monochrome (black-and-white). The host image is separated into its constituent primary hues. In this example, the CYMK separation procedure is employed, so that the host image is separated into:
a magenta (M) separation, 3
a yellow (Y) separation, 4
a black (K) separation, 5
a cyan (C) separation, 6

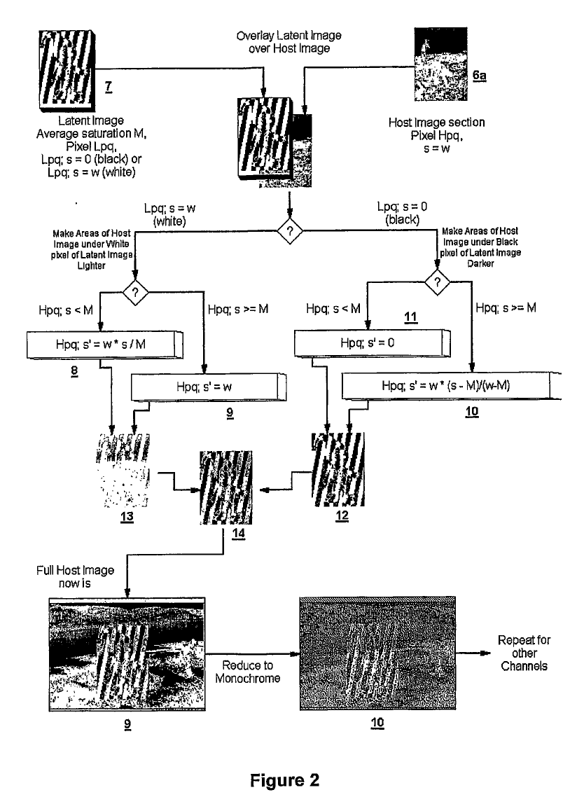

The hidden image 2 is typically input by a user in the same manner as the host image. The hidden image is, converted into a latent image 7 using, in this example, the PhaseGram technique. An area within which the latent image is to be hidden in the host image is identified, 1a. This area 1a has the same number and arrangement of pixels as the latent image 7. For each separation, the area is compared to the latent image 7. In FIG. 1, the area within which the latent image is to be concealed with the cyan separation is shown as 6a. This area 6a is compared with the latent image 7 by overlaying it 100 and an algorithm is applied to make areas of the host image section under a white pixel of the latent image lighter 12 and areas under black pixel of the latent image darker 13. This algorithm is depicted in detail in FIG. 2.

Each pixel H_{pq} in the section 6a, has the primary hue cyan in a saturation, s, which lies between 0≦s≦w (where w=the minimum saturation; 0=maximum saturation). The average saturation, s, of the average pixel in the latent image L_{pq} is M.

The method involves determining at step 200 whether s=0 or w for <_{pq}. Where s=0 for L_{pq}, the saturation of the corresponding pixel H_{pq} is adjusted to s′. This involves determining at step 202 whether the s of H_{pq} is <M or ≧M. The adjustment is to s′=(w*s)/M if the s of H_{pq}<M, at step 240, or to s′=w if the s of H_{pq}≧M, at step 230. The affected pixels in the host image are made correspondingly darker, as shown in image 12 of FIG. 1.

Where s=w for L_{pq}, the saturation of the corresponding pixel H_{pq} is adjusted to s′, after determining at step 204 whether s of H_{pq}<M or ≧M. The adjustment is to s′=(w*(s−M))/(w−M) if the s of H_{pq}<M, at step 210, or to s′=0 if the s of H_{pq}<M, at step 220. The affected pixels in the host image are made correspondingly lighter, as shown in image 13.

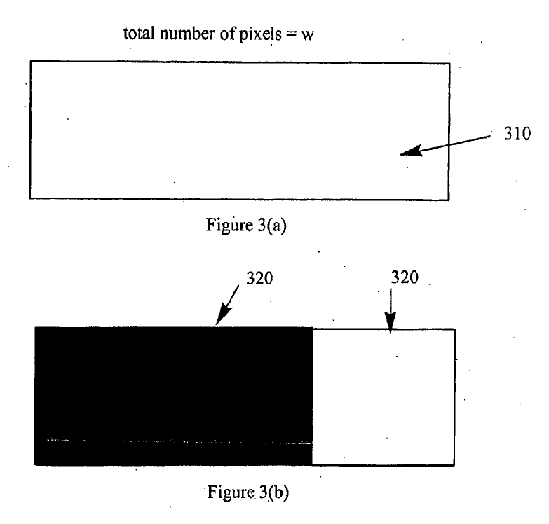

These equations originate in the need to imperceptibly embed the latent image within the host image. In order to do this, pixels in the host image which correspond to black pixels in the latent image must be made darker, while pixels in the host image which correspond to colourless pixels in the latent image, must be made correspondingly lighter. This is done while maintaining to be greatest extent possible, the overall saturation of the host image in the smallest possible areas. FIGS. 3 and 3B depict a hypothetical, pixellated portion L_{p′q′} 310 within a latent image L_{pq}. The total number of pixels in the area is w. In such an area, all of the pixels are constrained to be either of maximum (s=0) or minimum (colourless; s=w) saturation. The total number of pixels present, w, therefore corresponds to the maximum number of possible shades (saturations) that can be rendered using such a pixellated area. In FIG. 3B, a certain number of the pixels have been made maximally saturated 370, with the rest having minimum saturation 330. For convenience, the maximally saturated pixels have been separated from the colourless pixels and grouped together on the left-hand side of FIG. 3B. The average saturation of the pixellated area will therefore equal the absolute number of colourless pixels, M, multiplied by their saturation, w, plus the absolute number of maximally saturated pixels (w−M) multiplied by their saturation, 0, divided by the total number of pixels, w (FIG. 3).

That is, the average saturation of the area L_{p′q′} within the latent image L_{pq} will be

$$s ( {L}_{{p}^{′} {q}^{′}} ) = \frac{0 * ( w - M )}{w} + \frac{w ( M )}{w} = M \qquad ( 1 )$$

For this area to match the corresponding area H_{p′q′} in the host image H_{pq}, M will have to equal the average saturation, s′ (H_{p′q′}), of the host image within the matrix H_{p′q′}.

If the value of s′ (H_{p′q′}) is less than M, then this area is darker in the host image than in the latent image and intensity (saturation) must be removed from the area. That is, maximally saturated pixels within the host image in this area must be substituted with colourless ones. Thus, an additional number of colourless pixels must be created. The new saturation, s′, effectively, substitutes into equation (1) as follows:

$$s ( {L}_{{p}^{′} {q}^{′}} ) = \frac{0 * ( w - M )}{w} + \frac{{s}^{′} ( M )}{w}$$

Rearranging this equation gives:

s′(H_{p′q′})=(w*s)/M (2)

If, however, the value of s(H_{p′q′}) is greater than M, then this area is lighter in the host image than in the latent image and intensity (saturation) must be added to the area. That is, colourless pixels within the host image in this area must be substituted with maximally saturated ones. The new saturation, s′, effectively, substitutes into equation (1) as follows:

$$s ( {L}_{{p}^{′} {q}^{′}} ) = \frac{{s}^{′} * ( w - M )}{w} + \frac{w ( M )}{w}$$

Rearranging this equation gives:

s′=(w*(s−M))/(w−M) (3)

To reduce this to a pixel-by-pixel comparison, each pixel in the latent image L_{pq} can only have a saturation of s=0 (maximal saturation) or s=w (colourless).

Thus, if s(L_{pq})=w, and if s(H_{pq})<M, then equation (2) applies; that is

s′=(w*s)/M

In the case where s≧M however, s′ becomes larger than or equal to w. The latter is, of course, impossible, so that s′ is best set to:

s′=w

If, however, s(L_{pq})=0, and if s(H_{pq})≧M, then equation (3) applies; that is

s′=w*(s−M)/(w−M)

In the case where s<M however, s′ becomes zero or negative. The latter is impossible, so that s′ can effectively be set equal to 0; that is,

s′=0

Thus, intensity is decreased in pixels of the host image, corresponding to pixels of the latent image that are colourless. Moreover, intensity is increased in pixels of the host image corresponding to pixels of the latent image that are maximally saturated. This is all done in such a way that the average saturation in even the smallest collection of pixels is maintained as close to its previous average as possible.

The application of this algorithm therefore constitutes a form of dither in which intensity is redistributed in the smallest possible areas to thereby embed the latent image in the host image.

Returning now to FIG. 1; the resulting modified section of the host image having the primary hue cyan, 14, is substituted into the cyan separation of the host image 6, giving the revised cyan separation 9. This is reduced to a monochrome image 10.

This entire process is repeated for each of the other separations of the host image, 3, 4, 5. The revised separations are then recombined to give the securitized image.

### Example 2

### Colour Latent Image in Colour Host Image

Referring to FIG. 4: A host image 400 consists of a colour picture. The host image is separated 410 into its constituent colours separations using methods known to the art; in this case, these are the cyan (HC) 421, magenta (HM) 422, yellow (HY) 423 and black (HK) 424 separations.

A latent image 430 is similarly separated into its cyan (LC) 431, magenta (LM) 432, yellow (LY) 433 and black (LK) 454 separations. These separations may serve as the “original” separations in the creation of the securitized final image. Alternatively, these separations may be further processed to make them ready to be used as the “original” separations in the creation of the securitized final image.

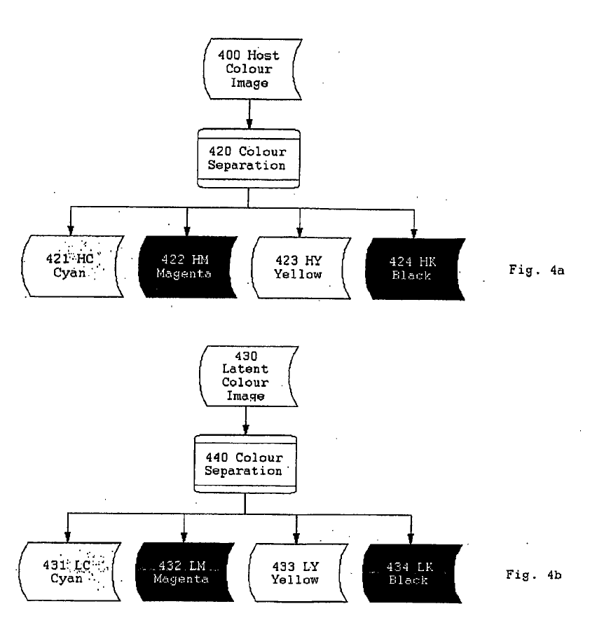

FIG. 5 depicts an exemplar flow-chart for further processing of the latent image separations in FIG. 4; in this case the further processing involves preparing the colour separations to incorporate a colour phasegram. Each of the cyan (LC), magenta (LM); yellow (LY) and black (LK) separations 431-434 are reduced to grey-scale images containing a pre-determined number of shades (N) 501-504. Each separation is then converted into a PhaseGram 511-514 using methods previously described. The intensity range of the resulting separated PhaseGrams are adjusted to match the intensity ranges of the original separations 521-524, using methods previously described. The intensity-matched images are now converted back to their respective hues, giving corrected cyan (PCc), magenta (PMc), yellow (PYc) and black (PKc) separations 531-534. These separations are now ready to be used to create the final, securitized image.

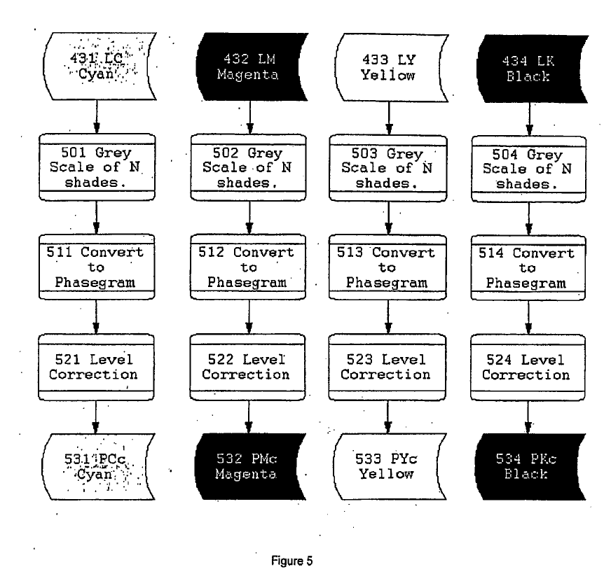

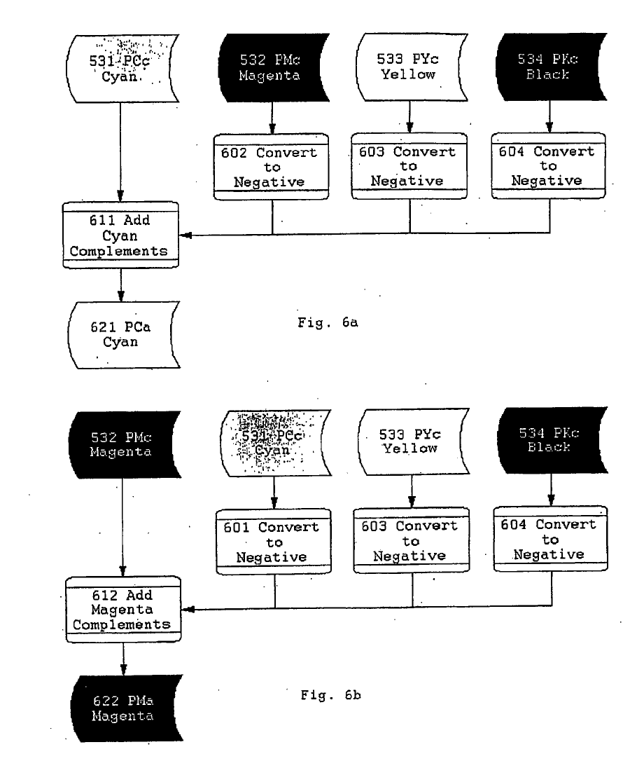

FIGS. 6A-6D depict a typical procedure for converting the “original” latent image separations into “revised” latent image separations. Each original separation has added to it, the corresponding saturations of its hues in the negatives of the other separations. This is necessary to properly balance the colours of the latent image within the host image. The resulting latent image separations are then dithered to give “revised” latent image separations in which the pixels have either maximum or minimum saturation.

Thus, as shown in FIG. 6A, the original cyan separation (PCc) 531 has added to it 611, the cyan components of the negatives 602,603,604 of the magenta 532, yellow 533, and black 534 separations. Following the required dithering, the resulting “revised” cyan separation is PCa 621. Similarly in FIG. 6B, the original magenta separation (PMc) 532 has added to it 612, the magenta components of the negatives 601,603,604 of the cyan 531, yellow 533, and black 534 separations. Following the required dithering, the resulting “revised” magenta separation is PMa 622.

FIGS. 6C and 6D show how this is extended to the yellow and black separations. Thus, the original yellow separation (PYc) 533 has added to it 613, the yellow components of the negatives 601,602,604 of the cyan 531, magenta 532, and black 534 separations. Following the required dithering, the resulting “revised” yellow separation is PYa 623. Similarly, the original black separation (PKc) 534 has added to it 614, the black components of the negatives 601,602,603 of the cyan 531, yellow 533, and magenta 532 separations. Following the required dithering, the resulting “revised” black separation is PKa 624.

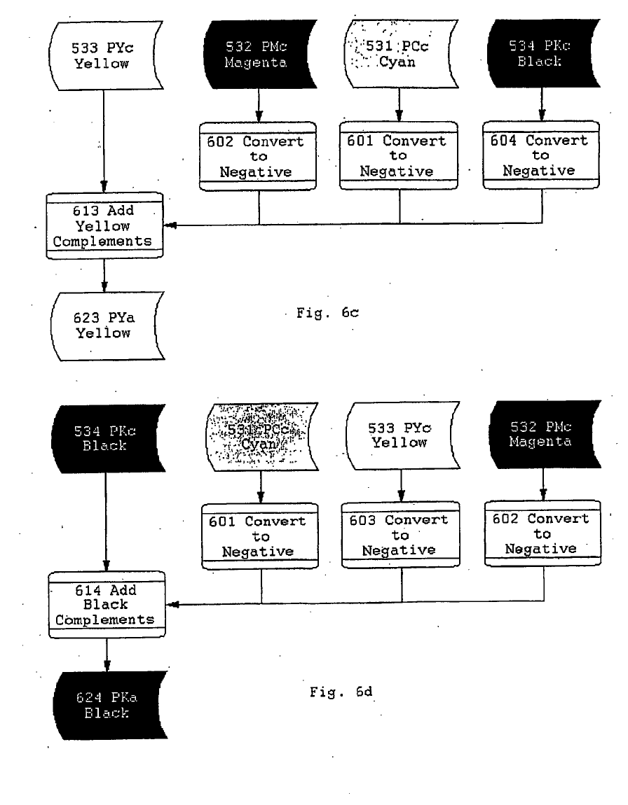

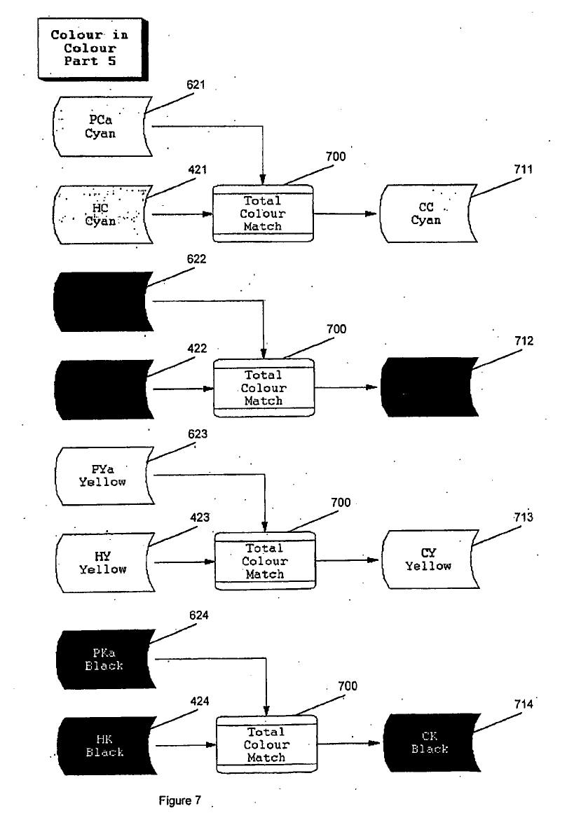

FIGS. 7A to 7D show how the host image is converted into final, securitized image by comparison with the corresponding revised latent image separations. Thus, the host cyan separation (HC) 421 is compared, pixel-by-pixel, with the revised latent cyan separation (PCa) 621. The algorithm 700 described in example 1 is applied, thereby generating the cyan separation (CC) 711 of the final, securitized image. Similarly, the host magenta separation (KM) 422 is compared, pixel-by-pixel, with the revised latent magenta separation (PMa) 622. The algorithm 700 described in example 1 is applied, thereby generating the magenta separation (CM) 712 of the final, securitized image.

The host yellow separation (HY) 423 is also compared, pixel-by-pixel, with the revised latent yellow separation 623 (PYa). The algorithm described in example 1 is applied 700, thereby generating the yellow separation (CY) 713 of the final, securitized image. Similarly, the host black separation (HK) 424 is compared, pixel-by-pixel, with the revised latent black separation (PKa) 624. The algorithm described in example 1 is applied 700, thereby generating the black separation (CK) of the final, securitized image.

The separations CC, CM, CY, and CK 711-714 can be combined using suitable methods known to the art, to create the final securitized image.

### Other Embodiments

The algorithms described above provide the broadest general contrast range and best concealment for most modulated digital images, however, other algorithms may be more suitable in certain applications. Moreover, other algorithms may be more suited to other concealment methods. Thus, persons skilled in the art will appreciate that a number of variations may be made to the foregoing embodiment of the invention. It is to be explicitly understood that all such variations are included within the scope of the invention.

Additionally, other renderings of the invention may be made. For example, colour spaces or separations of hue with corresponding complementary hues, known to the art, may be used in alternative embodiments.

Persons skilled in the art will appreciate that other latent image techniques can be used. For example, “Scrambled Indicia” are described in analogue form in U.S. Pat. No. 3,937,565 and in a computerized, digital version in Patent WO 97/20298. In the latter technique, the computer program effectively slices the image to be hidden into parallel slivers called “input slices”. These are then scrambled, generating a series of thinner “output slices” that are incorporated into an image in a form that is incoherent to the human eye. When viewed through a special device containing many microscopically small lenses, the original image is, however, reconstituted, thereby rendering the hidden image visible.

Scrambled images of this type may be incorporated into a visible background picture by matching the grey-scale or colour saturation of the hidden image to the background picture. This is achieved by adjusting the thickness of the features in the scrambled images to suit.

Latent images may also be formed by “modulation” of the line- or dot patterns used to print images. In order to print an image, professional printers use a variety of so-called “screening” techniques. Some of these include round-, stochastic-, line-, and elliptical-screens. Examples of these screens are shown in U.S. Pat. No. 6,104,812. Essentially, the picture is broken up into a series of image elements, which are typically dots or lines of various shapes and combinations. These dots and lines are usually extremely small, being much smaller than the human eye can perceive. Thus, images printed using such screens appear to the eye to have a continuous tone or density.

Hidden images can be created by juxtapositioning two apparently similar line or dot screens with one another. Processes in which an image is hidden by changing the position, shape, or orientation of the line elements used in printing screens are formally known as “line modulation”. Processes in which the dots in a printer's screens are deformed or moved to conceal an image are known as “dot modulation”. The theory of line and dot modulation is described by Amidror (Issac Amidror, “The Theory of the Moiré Phenomenon”, Kluwer Academic Publishers, Dordrecht, 2000, pages 185-187). When two locally periodic structures of identical periodicity are superimposed upon each other, the microstructure of the resulting image may be altered (without generation of a formal Moiré pattern) in areas where the two periodic structures display an angle difference of α=0°. The extent of the alteration in the microstructure can be used to generate latent images which are clearly visible to an observer only when the locally periodic structures are cooperatively superimposed. Thus, the latent images can only be observed when they are superimposed upon a corresponding, non-modulated structure. Accordingly, a modulated image can be incorporated in an original document and a decoding screen corresponding to the non-modulated structure used to check that the document is an original—e.g. by overlaying a modulated image with a non-modulated decoding screen to reveal the latent image.

Examples of concealing latent images using line modulations are described in various patents, including the following: U.S. Pat. No. 6,104,812, U.S. Pat. No. 5,374,976, CA 1,066,109, CA 1,172,282, WO03/013870-A2, U.S. Pat. No. 4,143,967, WO91/11331, and WO2004/110773 A1. One such technique, known as Screen Angle Modulation, “SAM”, or its micro-equivalent, “μ-SAM”, is described in detail in U.S. Pat. No. 5,374,976 and by Sybrand Spannenberg in Chapter 8 of the book “Optical Document Security, Second Edition” (Editor: Rudolph L. van Renesse, Artech House, London, 1998, pages 169-199), both incorporated herein by reference. In this technique, latent images are created within a pattern of periodically arranged, miniature short-line segments by modulating their angles relative to each other, either continuously or in a clipped fashion. While the pattern appears as a uniformly intermediate colour or grey-scale when viewed macroscopically, a latent image is observed when it is overlaid with an identical, non-modulated pattern on a transparent substrate.

Examples of concealing latent images using dot modulations are described in various patents, including WO02/23481-A1.

Further security enhancements may include using colour inks which are only available to the producers of genuine bank notes or other security documents, the use of fluorescent inks or embedding the images within patterned grids or shapes.

The method of above embodiment of the present invention can be used to produce security devices to thereby increase security in anti-counterfeiting capabilities of items such as tickets, passports, licenses, currency, and postal media. Other useful applications may include credit cards, photo identification cards, tickets, negotiable instruments, bank cheques, traveller's cheques, labels for clothing, drugs, alcohol, video tapes or the like, birth certificates, vehicle registration cards, land deed titles and visas.

Typically, the security device will be provided by embedding the securitized image within one of the foregoing documents or instruments and separately providing a decoding screen or screens. However, the securitized image could be carried by one end of a banknote while the decoding screen is carried by the other end to allow for verification that the note is not counterfeit.

Alternatively, the preferred embodiments may be employed for the production of novelty items, such as toys, or encoding devices.

1. A method of forming a securitized image comprising:
a) obtaining a host image which is to be visible to an observer;
b) obtaining a latent image to be concealed within the host image;
c) adjusting the saturation of regions of at least one of the host image and the latent image such that when the latent image and the host image as adjusted are subsequently combined, the saturation of the combined regions will more closely approximate the saturation of corresponding regions of the original host image; and
d) combining the latent image and host image as adjusted to form a securitized image.

2. A method as claimed in claim 1, comprising adjusting the saturation to seek to minimise the difference between the saturation of the combined, latent image and host image as adjusted and the original host image.

3. A method as claimed in claim 1, wherein adjusting the saturation of regions of at least one of the host image and the latent image comprises:
separating each of the host image and the latent image into a set of digitized greyscale or colour saturations which fully define each image when combined,
applying within each greyscale or colour saturation, a matching algorithm to match the grey-scale or colour characteristics of image elements in the latent image with corresponding image elements in the same greyscale or colour saturations of the host image.

4. A method as claimed in claim 1, wherein combining the latent image and host image as adjusted comprises:
transforming selected image elements within each greyscale or colour saturation in the host image according to the visual characteristics of the selected, corresponding image elements of the latent image to form revised separations; and
combining the revised separations to thereby create the securitized image.

5. A method as claimed in claim 1, wherein obtaining a latent image comprises selecting one or more images that are to be hidden within the host image and forming a latent image containing the one or more images.

6. A method as claimed in claim 1, further comprising:
a) obtaining at least a further latent image to be concealed;
b) adjusting the saturation of regions of at least one of the securitized image and the further latent image such that when the further latent image and the securitized image as adjusted are subsequently combined, the saturation of the combined regions will more closely approximate the saturation of corresponding regions of the original securitized image; and
c) combining the further latent image and securitized image as adjusted to form a further securitized image.

7. A method as claimed in claim 1, wherein the latent image is an encoded hidden image which can be decoded using a decoding screen.

8. A method as claimed in claim 7, comprising forming a latent image by a technique selected from the group of Scrambled Indicia, Line- or Dot-Modulation, PhaseGram; and BinaGram.

9. A method as claimed in claim 7, wherein the latent image is a digitally modulated image.

10. A method as claimed in claim 5, wherein a plurality of latent images are concealed within a visible, securitized image in such a manner that they can each be decoded by a different decoder.

11. A security device comprising a securitized image in which a latent image is concealed within a host image by adjusting the saturation of regions of at least one of the host image and the latent image such that when the latent image and the host image as adjusted are subsequently combined, the saturation of the combined regions will more closely approximate the saturation of corresponding regions of the original host image and combining the latent image and host image as adjusted to form a securitized image.

12. A security device as claimed in claim 11, wherein the latent image is an encoded hidden image which can be decoded using a decoding screen.

13. A security device as claimed in claim 12, wherein the latent image is a digitally modulated image.

14. A security device as claimed in claim 12, wherein a plurality of latent images are concealed within a visible, securitized image in such a manner that they can each be decoded by a different decoder.

15. Computer program code which when executed by a computer causes the computer to carry out a method of forming a securitized image comprising:
a) obtaining a host image which is to be visible to an observer;
b) obtaining a latent image to be concealed within the host image;
c) adjusting the saturation of regions of at least one of the host image and the latent image such that when the latent image and the host image as adjusted are subsequently combined, the saturation of the combined regions will more closely approximate the saturation of corresponding regions of the original host image; and
d) combining the latent image and host image as adjusted to form a securitized image.

16. Computer program code as claimed in claim 15 arranged to adjust the saturation to seek to minimise the difference between the saturation of the combined latent image and host image as adjusted and the original host image.

17. Computer program code as claimed in claim 16 arranged to adjust the saturation of regions of at least one of the host image and the latent image by:
separating each of the host image and the latent image into a set of digitized greyscale or colour saturations which fully define each image when combined,
applying within each greyscale or colour saturation, a matching algorithm to match the grey-scale or colour characteristics of image elements in the latent image with corresponding image elements in the same greyscale or colour saturations of the host image.

18. Computer program code as claimed in claim 17 arranged to combine the latent image and host image as adjusted by:
transforming selected image elements within each greyscale or colour saturation in the host image according to the visual characteristics of the selected, corresponding image elements of the latent image to form revised separations; and
combining the revised separations to thereby create the securitized image.

19. Computer program code as claimed in claim 15, wherein the computer program code is arranged to allow a user to input a host image to thereby obtain the host image.

20. Computer program code as claimed in claim 15, wherein obtaining a latent image comprises selecting one or more images that are to be hidden within the host image and forming a latent image containing the one or more hidden images.

21. Computer program code as claimed in claim 20 arranged to allow a user to select one or more images to be hidden.

22. Computer program code as claimed in claim 15 arranged to:
a) obtain at least a further latent image to be concealed;
b) adjust the saturation of regions of at least one of the securitized image and the further latent image such that when the further latent image and the securitized image as adjusted are subsequently combined, the saturation of the combined regions will more closely approximate the saturation of corresponding regions of the original securitized image; and
c) combine the further latent image and securitized image as adjusted to form a further securitized image.

23. Computer program code as claimed in claim 15, the latent image is an encoded hidden image which can be decoded using a decoding screen.

24. Computer program code as claimed in claim 17 arranged to form a latent image by a technique selected from the group of Scrambled Indicia, Line- or Dot-Modulation, PhaseGram; and BinaGram.

25. Computer program code as claimed in claim 23, wherein the latent image is a digitally modulated image.

26. Computer program code as claimed in claim 20 arranged to conceal a plurality of latent images within a visible, securitized image in such a manner that they can each be decoded by a different decoder.

27. A computing system for producing a securitized image comprising:
an image input section arranged to obtain a host image and a latent image to be concealed within the host image; and
an image processing section arranged to:
adjust the saturation of regions of at least one of the host image and the latent image such that when the latent image and the host image as adjusted are subsequently combined, the saturation of the combined regions will more closely approximate the saturation of corresponding regions of the original host image; and
combine the latent image and host image as adjusted to form a securitized image.

28. A computing system as claimed in claim 27, wherein the image processing section is arranged to:
adjust the saturations by separating each of the host image and the latent image into a set of digitized greyscale or colour saturations which fully define each image when combined,
apply within each greyscale or colour saturation, a matching algorithm to match the grey-scale or colour characteristics of image elements in the latent image with corresponding image elements in the same greyscale or colour saturations of the host image.

29. A computing system as claimed in claim 28 arranged to combine the latent image and host image as adjusted, transforming selected image elements within each greyscale or colour saturation in the host image according to the visual characteristics of the selected, corresponding image elements of the latent image to form revised separations; and
combining the revised separations to thereby create the securitized image.
